(19) United States
(12) Patent Application Publication
(10) Pub. No.: US 2016/0069126 A1
(43) Pub. Date: Mar. 10, 2016

(54) Beveled edge safety door assembly

(71) Applicant: ROBERT HAROLD ROBINSON, CHOWCHILLA, CA (US)

(72) Inventor: ROBERT HAROLD ROBINSON, CHOWCHILLA, CA (US)

(21) Appl. No.: 14/756,051

(22) Filed: Jul. 27, 2015

Related U.S. Application Data
(60) Provisional application No. 62/070,832, filed on Sep. 8, 2014.

(51) Int. Cl. E06B 7/36

(52) U.S. Cl. CPC E06B 7/362; E06B 7/367

(57) ABSTRACT

A beveled edge safety door assembly consisting of a mitred edge rather than the standard 90 degrees, said mitred edge running vertically along the hinge side of the door which creates a triangular safety gap when closed, which provides extra space between door and jamb to prevent the crushing of human fingers, and further containing a lengthy continuous hinge preferably extending from the base of the door to its top, which prevents fingers from entering therefrom, and still further containing a flexible rubberlike doorstop which gives way to a human finger or other similar objects if inserted therein, thereby preventing a serious injury should the door be inadvertently closed.

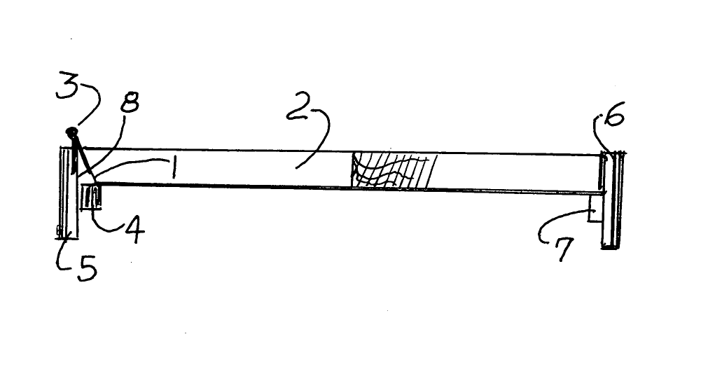

### BACKGROUND OF THE INVENTION

1. Field of the Invention

The present invention relates primarily to home doors, interior or exterior, right- or left-handed, metal-lined or wood, and in many cases even bifold doors as well as garage doors. Additionally, this door concept is also applicable to schools, daycare centers, kindergarten classes, hospitals and convalescent homes. The beveled edge concept prevents a human finger or fingers from being crushed or severed in the hinge side of a door when closed, said beveled edge mitred at a sufficient angle other than the standard 90 degrees, which forms a triangle-shaped “safety gap.” Still further, the invention utilizes a continuous hinge instead of the multiple individual butt hinges and a flexible rubberlike doorstop. In unison, the aforementioned three elements incorporate the primary embodiment of the beveled edge safety door concept. The rubberlike doorstop on my invention gives way whenever a finger is caught between the door's edge and jamb; and aided by the extra space of the safety gap, no injury occurs. In addition, the long, singular continuous hinge provides complete protection on the reverse side of the door.

2. Description of the Prior Art

On conventional doors of which I am aware, all four sides are generally cut at 90 degrees. The hinge side of a standard door can deliver up to 80,000 pounds per square inch, which can crush an English walnut. The hinge side of a conventional door, when closed, will compress down to the approximate thickness of a dime. In addition, the conventional doorstop, which is generally made of wood molding or of a similar by-product, can actually substitute as a “cutting tool,” thereby producing an even more serious injury. Every year in the United States alone, over 15,000 children have their finger or fingers crushed or severed in the hinge side of a home door.

### SUMMARY OF THE INVENTION

Objectives of the invention include providing a door which prevents serious and painful injuries to fingers which might inadvertently be placed in the hinge side of a door. The beveled edge provides the necessary clearance to prevent such accidents. In addition, these injuries are unnecessary. The beveled edge safety door addresses this problem by eliminating lawsuits, excruciating injuries as well as preventing a lifetime of disfigured hands, and further eliminating costly hospital visits and surgeries.

Another object of the invention is that it provides “peace of mind” to parents by just knowing that their children will never be injured senselessly in a home door.

Still another object of the invention is that it would remain economical to manufacture, since it requires no expensive parts, nor does it require any extensive extra labor to produce. The beveled edge is easily cut in the hinge-side stile, and the continuous hinge, which is a new use of a known process, could easily be transferred to standard doors. The rubberlike doorstop would be a rather simple unit to manufacture, and all materials are rather inexpensive and plentiful.

Still a further object of the invention is that it retains the same attractive appearance of a normal door.

In summation, it would appear to be an injustice against children and older adults for a door company to refuse to make every effort possible to protect precious fingers. Other tools, especially for adults, have many safety features. This kind of safety door is long overdue.

### BRIEF DESCRIPTION OF THE DRAWING

The single drawing FIGURE is a top plan view of a pre-hung door with the head jamb removed, illustrating the beveled edge, continuous hinge, triangular safety gap and the rubberlike doorstop. (Because the home door is such a well-known item, a single drawing FIGURE should suffice. Also, the items in the drawing may be somewhat dis-proportionate to one another in actual size.)

### DESCRIPTION OF THE PREFERRED EMBODIMENT

The present invention will be more fully understood by reference to the following description thereof when read in conjunction with the attached drawing FIGURE.

Referring to the drawing, the beveled edge 1 is mitred on the hinge-side edge of the conventional door 2 instead of the standard 90 degrees, which forms a triangular safety gap 8 whenever the door is closed. Safety gap 8 can be up to three quarters of an inch at its widest point, more or less, which creates enough extra space between the door's edge and hinge-side jamb 5 which prevents a finger from being crushed or severed.

A continuous hinge 3 is fastened to the beveled edge 1 in much the same fashion as in conventional doors with the corresponding swivel portion of the hinge fastened to the hinge-side jamb 5. With the door in the closed position, one can readily see the triangular safety gap 8.

The continuous hinge 3 is a singular unit preferably equal to the entire height of the door and may or may not be countersunk since it would generally require a thinner gauge metal than the standard hinges. The length of the hinge and volume of screws would be at the preference of manufacturers.

The rubberlike doorstop 4 is in lieu of the standard wooden doorstop and can be hollow for more flexibility. The doorstop 4 is also somewhat larger, which is designed to conceal the safety gap 8 whenever the door is in the closed position. Only the doorstop on the hinge-side jamb need be rubberlike.

Jamb 6 on the lock side is basically standard, with wooden doorstop 7 as in conventional doors. The doorstop on the head jamb, which is not shown in the drawing, is also of standard material, size and design.

### IN GENERAL

In the embodiment of the improved invention illustrated in the drawing and described above, the beveled edge safety door assembly is a long-awaited commodity for children now and in the future. Other than designs and improvements in materials and hardware, there has been virtually no emphasis on safety for today's doors. Every room in the home may not absolutely require a safety door, but at least one should be installed in every child's room, playroom, bathroom, or any other room in which children and babies congregate frequently. Even if the beveled edge safety door should cost a few dollars more to produce, most buyers would be willing to pay it. At least, the safety door should be an option.

Changes in shape, size and rearrangement of details and parts such as come within the purview of the invention claimed may be resorted to in actual practice, if desired.

In the foregoing description, certain terms have been used for brevity, clearness and understanding but not limited therefrom beyond the requirements of the prior art, because such terms are used for descriptive purposes and are intended to be broadly construed.

Having now described the principles, features and discoveries of the invention, the manner in which the improved beveled edge safety door assembly is constructed, assembled and operated, the new construction and characteristics, and the advantages, new and useful results obtained, the new and useful arrangements, structures, elements, devices, parts and combinations are set forth in the appended claims.

I claim:

1. A beveled edge safety door assembly in which the hinge side is mitred other than 90 degrees, said degrees being sufficient enough to provide an adequate triangular safety gap means which would prevent a human finger or other similar objects from being crushed or severed if inadvertently placed therein prior to the door's being closed, said beveled edge means extending from the bottom rail of the door to its entire height, or at least high enough that a child cannot reach.

2. A beveled edge safety door assembly in which a continuous hinge means is in lieu of multiple individual butt hinges, said continuous hinge means extending from the bottom rail of said door to the top, or at least to a height that a child cannot reach, said continuous hinge means being sufficient enough to prevent a human finger or other similar objects from entering the separation between the jamb and the door's beveled edge, particularly on the reverse side whenever said door is in the opened position.

3. A beveled edge safety door assembly in which a rubberlike doorstop means, preferably being hollow for more flexibility, is affixed preferably with an adhesive substance to the hinge-side jamb in lieu of the standard doorstop molding, said rubberlike doorstop means extending from the base of the jamb to the head jamb, and further the rubberlike doorstop means preferably being larger than standard molding in order to conceal the triangular safety gap means whenever the door is in the closed position, and still further said rubberlike doorstop means preferably being the same color and design as the molding on the opposite side jamb as well as the molding on the head jamb, thus maintaining the normal appearance.
